(19) United States
(12) Patent Application Publication
(10) Pub. No.: US 2019/0283057 A1
(43) Pub. Date: Sep. 19, 2019

(54) PACKAGING CONTAINER WITH A PUMP DISPENSER

(71) Applicant: MATOK V'KAL LTD, Ceasarea (IL)

(72) Inventors: Noam KAPLAN, Tel Aviv (IL); Tal LEIZER, Zikhron Yaacov (IL); Sagi SLUTSKI, Zikhron Yaacov (IL)

(21) Appl. No.: 16/302,114

(22) PCT Filed: Feb. 11, 2018
(86) PCT No.: PCT/IL2018/050153

§ 371 Date: Nov. 16, 2018

(30) Foreign Application Priority Data
Feb. 20, 2017 (IL) 250680

(51) Int. Cl. B05B 11/00; B65D 47/20; B65D 35/14; B05B 11/04

(52) U.S. Cl. CPC B05B 11/00412; B65D 47/2018; B05B 11/04; B05B 11/0056; B65D 35/14

(57) ABSTRACT

The subject matter discloses a package for liquid edible materials, comprising a collapsible container for storing said liquid edible materials, a container neck attached to the inner sidewalls of the upper portion of said collapsible container, and designed to be detached from said container, a pump dispenser comprises a pump container inserted into the collapsible container through the container neck, a movable cap cover mounted on said pump dispenser and comprising a nozzle extending outwards, said nozzle is designed to release said edible materials, wherein said cap cover is designed to be pressed downwards and upwards and thereby to dispense the liquid, supporting edges extending upwards from the container neck, wherein said nozzle is moved between the supporting edges; a wearable coverage to contain the collapsible container inserted into said wearable coverage, said wearable coverage comprises a socket allowing the pump dispenser and the nozzle to move upwards and downwards

### FIELD OF THE INVENTION

The present invention generally relates to the field of packaging edible materials and more specifically to the field of packaging which allows easy and handy consumption of liquid edible materials by a pump dispenser.

### BACKGROUND OF THE INVENTION

Pump dispensers have become extremely popular for a variety of reasons. Pump dispensers can be utilized in multiple fields such as detergents, perfumes, pharmaceutical products, and the like. In many cases, these products require a high-pressure environment within a main container or the bottle. Such a high-pressure is required to be higher than the pressure at the atmosphere. The pressure differential between the inner pressure and the atmospheric pressure level creates a jet of a gas or liquid released out to the atmosphere. In some cases, the pressure differential between the inner pressure and the atmospheric pressure may be achieved by an airless-pump dispensing the material required to be sprayed out. In such cases, the airless-pump may utilize a spring and an additional sealed container located within the airless pump, wherein the sealed container can comprise a relatively small amount of the material. The airless-pump can utilize the spring to create a high-pressure environment within the additional sealed container and thereby release the material required to be sprayed out, outside to the atmosphere.

In cases which an airless-pump is used, one of the main challenge lies in the fact that the airless-pump is required to reach the material residing within the main container. Furthermore, there is no built-in mechanism which pushes the material residing within the main container towards the pump and causes the airless-pump to be dipped in said material. One of the solution to overcome this challenge may be to attach a long cannula to the air-less pump. The cannula may be designed to reach the bottom of the main container and thereby to be dipped in the material even in cases a small amount of material remains within the main container.

### SUMMARY OF THE INVENTION

The present invention discloses a Handheld and Collapsible Packaging Container (HPC) attached to a pump dispenser and designed for storage and dispensing of a liquid edible material. The pump dispenser may be connected to the HPC via a container neck attached to the inner sidewalls of the collapsible container, wherein the container neck seals the collapsible container of the HPC. Thus, when pumping the liquid out of the HPC, the pump dispenser may create a vacuum within the collapsible container. The vacuum created by the pump dispenser may be utilized to push the liquid edible material toward the pump and enable emptying of the HPC. In some cases, the pump dispenser of the HPC may be designed to release the liquid edible material in aerosol form. In some other cases, the pump dispenser may be replaced with a pump designed to release the liquid edible material in liquid form. In some embodiments of the disclosed subject matter, the pump dispenser may comprise a one-way valve designed to prevent the liquid edible material to flow from the pump back to the HPC. In some cases, such a pump may be an airless-pump designed to dispense the liquid edible material without an inner pressure. In some cases, the HPC may be inserted to a wearable coverage designed to protect the collapsible container and facilitate its carrying. The wearable coverage may also allow a person to carry the HPC during outdoor activities.

The present invention discloses a package for liquid materials, comprising a collapsible container for storing said liquid materials, a container neck attached to inner sidewalls of the collapsible container, wherein said container neck seals said collapsible container, a pump dispenser connected to said container neck and configured to reach said liquid material stored within said collapsible container, wherein said pump dispenser is configured to dispense said liquid material by creating a vacuum within said collapsible container.

In some cases, the package further comprises a wearable coverage attached to the container neck, wherein said package for liquid materials is inserted into said wearable coverage. In some cases, the package further comprises a one-way valve connected to the pump dispenser, wherein the one-way valve prevents the liquid material to flow from the pump dispenser to said collapsible container. In some cases, the pump is configured to release the liquid material in a form of an aerosol spray. In some cases, the pump is configured to release the liquid material in a form of a liquid.

In some cases, the container neck is adhered to the collapsible container by adhesives comprising Cyanoacrylates. In some cases, the container neck is adhered to the collapsible container by hot melted adhesives. In some cases, the container neck is adhered to the collapsible container by cold adhesives. In some cases, the container neck is welded to the collapsible container by laser welding. In some cases, the container neck is welded to the collapsible container by heat fusion. In some cases, the container neck is welded to the collapsible container by heat sealing. In some cases, the container neck is welded to the collapsible container by ultrasonic welding.

In some cases, the collapsible container is at a scale of a palm and designed to be held by a hand of a person. In some cases, the container neck comprises a hollow section extending from an inner portion of the container to the top of the neck. In some cases, the pump dispenser slides in the hollow section. In some cases, the pump dispenser further comprises a narrow rod designed to be inserted into the collapsible container and reach the liquid material. In some cases, the pump dispenser further comprises a cap cover designed to be pressed downwards and upwards. In some cases, the cap cover is mounted on bellows member, wherein the liquid material is released from the package when the cap cover is pressed downwards. In some cases, the pump dispenser further comprises a pump tube configured to be inserted into the collapsible container. In some cases, the liquid material is an edible liquid material.

In some cases, the container neck further comprises supporting edges extending upwards from a body of the container neck 505 and designed to limit a lateral movement of the pump. In some cases, the container neck comprises protuberant strips extending from a body of the container neck and designed to be fastened to inner sidewalls of the collapsible container. In some cases, the collapsible container is compounded of films. In some cases, the collapsible container is compounded of films comprising PLA. In some cases, the collapsible container is compounded of films comprising biodegradable material. In some cases, the collapsible container is compounded of films comprising polymers. In some cases, the collapsible container is compounded of films comprising paper. In some cases, the collapsible container is compounded of films comprising metallic ingredients. In some cases, the collapsible container is compounded of films formed with acrylic acid. In some cases, the liquid materials is a cream, or lotion, or emollient, or ointment, or paste.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows an HPC with a pump dispenser, in accordance with exemplary embodiments of the disclosed subject matter;

FIG. 2 shows a closed hand holds an HPC and operates a pump to release the liquid edible material stored within the collapsible container of the HPC, in accordance with exemplary embodiments of the disclosed subject matter;

FIG. 3 shows an airless-pump dispenser designed to be connected to a HPC, in accordance with exemplary embodiments of the disclosed subject matter;

FIG. 4A shows a disassembled HPC inserted into a wearable coverage, in accordance with exemplary embodiments of the disclosed subject matter;

FIG. 5 shows a collapsible container neck designed to be attached to the inner sidewalls of a collapsible container, in accordance with exemplary embodiments of the disclosed subject matter;

FIG. 6A shows a collapsible container neck and collapsible container, in accordance with exemplary embodiments of the disclosed subject matter;

FIG. 6B shows a collapsible container neck inserted into a collapsible container, in accordance with exemplary embodiments of the disclosed subject matter;

FIG. 7A shows a lateral view of a cross section of a HPC comprising a liquid edible material, in accordance with exemplary embodiments of the disclosed subject matter;

FIG. 7B shows a lateral view of a cross section of a collapsed HPC comprising a liquid edible material, in accordance with exemplary embodiments of the disclosed subject matter;

FIG. 8A shows a front view of a HPC comprising a liquid edible material, in accordance with exemplary embodiments of the disclosed subject matter; and,

FIG. 8B shows a front view of a HPC which is partially full with a liquid edible material, in accordance with exemplary embodiments of the disclosed subject matter.

### DETAILED DESCRIPTION OF THE INVENTION

The present invention discloses a Handheld and Collapsible Packaging Container (HPC) for storing and dispensing liquid material. The liquid material may be edible or non-edible. The edible liquid material stored in the HPC can comprise ingredients such as, carbohydrate, protein, oil, vitamins, salts, water, cellulose, medicines, beverage, or a liquid mix of any thereof. The non-edible liquid material stored in the HPC can comprise ingredients such as paint in a liquid form, sun-screen cream, lachrymatory agent, perfume, deodorant, make-up formed as liquid, lotion, cream, emollient, ointment, gel, paste, Ventolin and the like. For simplicity, the description below refers mainly to edible liquid materials.

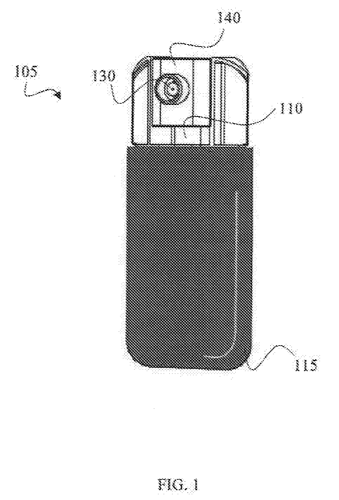

FIG. 1 shows an HPC with a pump dispenser, in accordance with exemplary embodiments of the disclosed subject matter. HPC 105 comprises a collapsible container 115 sealed by a collapsible container neck 110 and a pump dispenser 140. The pump dispenser 140 may be designed to draw the liquid edible material out from the collapsible container 115 and thereby to reduce the pressure level existing in the collapsible container 115. The collapsible container 115 is designed to collapse as a result of the higher pressure exerted on the collapsible container 115 by the atmospheric pressure. Collapsing of the sidewalls of the collapsible container 115 forces the liquid edible material residing in the collapsible container 115 to flow upwards towards the pump dispenser 140. The collapsible container 115 may also be constructed to be squashed by the hand of a user utilizing the HPC 105 and thereby to support the flow of the liquid edible material towards the pump dispenser 140.

In some embodiments of the disclosed subject matter, the pump dispenser 140 may also be designed to move downwards and upwards, and thereby to draw the liquid edible material out from the collapsible container 115. Thus, the pump dispenser 140 can draw up the liquid edible material resides within the collapsible container 115 as a result of pushing the pump dispenser 140 downwards, and then release the liquid edible material out through orifice 130 as a result of loosening the pressure exerted on the pump dispenser 140. The orifice 130 is a portion of the pump dispenser 140. For example, an athlete utilizing an HPC 105 comprises a liquid carbohydrate in a running course. The athlete can bring the orifice 130 close to the mouth, press the pump dispenser 140 downwards via a finger, then loosen the pressure on pump dispenser 140 and thereby to cause the liquid carbohydrate to flow out via the orifice 130 to the athlete's mouth.

In some possible embodiments of the disclosed subject matter, the pump dispenser 140 may seal the collapsible container 115 and thereby prevent ingress of air pressed from the outside into the collapsible container 115. Thus, a closed environment with a vacuum may be created while removing the liquid edible material from the collapsible container 115. Such a closed environment may push the liquid edible material towards the pump dispenser 140 each time the user of the HPC 105 extracts liquid from the HPC 105. In some cases, a person may also be able to squeeze the collapsible container 115 and thereby to release additional liquid edible material, contained in the collapsible container 115.

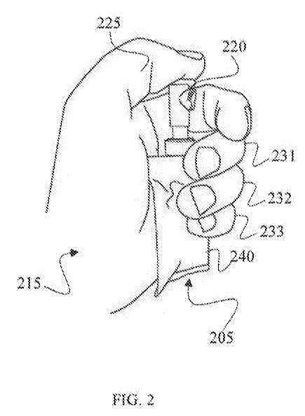

FIG. 2 shows a closed hand holds an HPC and operates a pump to release the liquid edible material stored within the collapsible container of the HPC, in accordance with exemplary embodiments of the disclosed subject matter. FIG. 2 shows the hand 215 which holds the HPC 205 in a fist-shaped holding. The hand 215 holds the collapsible container 240 of HPC 205 by using a grip of the fingers 231, 232 and 233 which clutch the collapsible container 240 against the palm of the hand 215. Thus, the pressure exerted by the fingers, 231, 232 and 233 may push the liquid edible material upwards toward the pump dispenser 220. The person utilizes the HPC 205 can use the thumb 225 to press the pump dispenser 220 downwards in order to release the liquid edible material which may reside within the collapsible container 240. In some cases, the pump dispenser 220 may seal the collapsible container 240 in order to prevent liquid edible material from excessive exposure to air, light, or moisture, thus increase the life span of the liquid edible material.

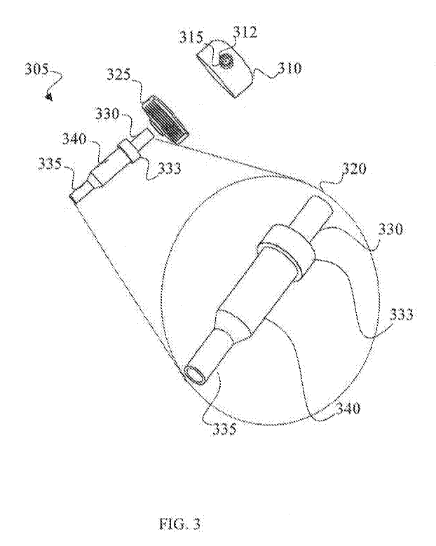

FIG. 3 shows an airless-pump dispenser designed to be connected to a HPC, in accordance with exemplary embodiments of the disclosed subject matter. Airless-pump dispenser 305 is designed to be connected to an HPC and dispense the liquid edible material which may reside within the HPC. The pump dispenser 305 comprises a cap cover 310 designed to be pressed downwards and upwards by the person using the pump dispenser 305 for drawing out the liquid edible material via orifice 312 located at the middle of nozzle 315. The term downwards refers to pushing the cap cover towards the collapsible container. The cap cover 310 can also be mounted on bellows member 325 which functions as a spring mechanism. For example, in case a person presses the cap cover 310 downwards and then releases the pressure, the bellows member 325 can stretch up, press the cap cover 310 upwards and thereby allow the liquid material to release out via orifice 312. The bellows member 325 is also designed to be connected to the container 340 illustrated in illustration 320 which demonstrates the pump dispenser 305 mechanism. Thus, piston 330 can be fully inserted into the bellows member 325 which can be connected to the container 340 via ring member 333. The piston 330 may be designed to be inserted into the bellows member 325 and connected to the cap cover 310 in one side, and be inserted into the container 340 on the other side. Thus, the movements upwards and downwards of piston 330 can draw out a portion of the liquid material stored in the HPC. In some cases, the bellows member 325 may be affixed to inner sidewalls of the cap cover 310. In some other cases, the piston 330 may be affixed to the bottom portion of the cap cover 310. The affixing processes of the cap cover 310 to the other parts of the pump dispenser 305 can utilize hot melted adhesives, cold adhesives, welding, and the like.

The pump dispenser 305 also comprises a narrow rod 335 designed to be inserted into the collapsible container of the HPC and reach the liquid material stored in said HPC. In some cases, the collapsible container of the HPC may be adhered to the ring member 333 so that the collapsible container may be sealed by the ring member 333. In some embodiments of the disclosed subject matter, the collapsible container of the HPC may be connected to a rigid neck inserted into the collapsible container and utilized to seal the collapsible container of the HPC. Thus, the rigid neck may be glued or welded to the collapsible container and also glued or welded to the pump dispenser 305.

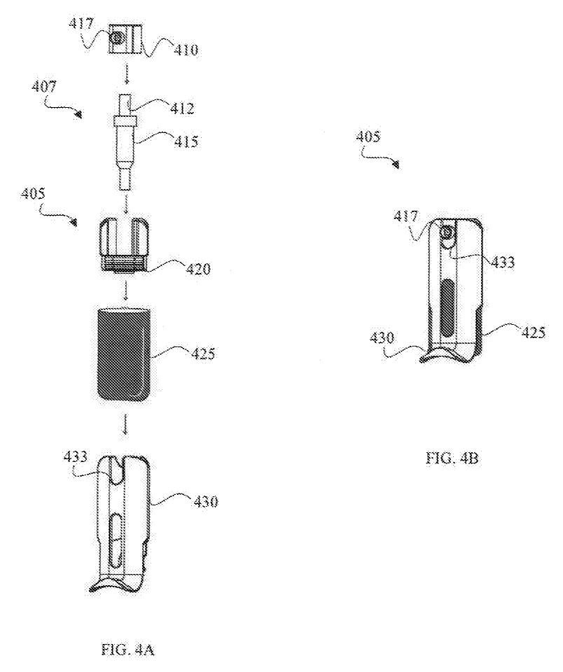

FIG. 4A shows a disassembled HPC inserted into a portable coverage, in accordance with exemplary embodiments of the disclosed subject matter. HPC 405 comprises a pump 407 designed to dispense the liquid edible material residing in the collapsible container 425. Pump 407 comprises a dispenser head 410 designed to be mounted on the piston 412. The piston 412 may be connected to the pump container 415. Collapsible container 425 can comprise a liquid nutrition material which may be drawn out by the piston 412 and then be released out via nozzle 417. For example, in order to release a liquid edible material via the pump 407, a person can press the pump dispenser head 410 downwards, towards the collapsible container 425 and release the pressure exerted on the pump dispenser head 410. The releasing of the pump dispenser head 410 may cause the pump dispenser head 410 to move upwards and thereby release the liquid edible material out to the air, for example as aerosol spray.

The pump container 415 can also be inserted into the collapsible container neck 420. The collapsible container neck 420 may be a rigid chassis designed to be inserted into the collapsible container 425. In some cases, the collapsible container neck 420 may be adhered to the inner sidewalls of the collapsible container 425 with an adhesive. In some cases, the adhesive may be hot melt adhesive, for example an adhesive comprising Polyethylene. In some other cases, the collapsible container neck 420 may be adhered to the HPC container via a cold adhesive, for example an adhesive comprising Cyanoacrylates. In some embodiments of the disclosed subject matter, the collapsible container neck 420 may be welded to the inner sidewalls of the collapsible container 425. Such a welding may be a laser welding, heat fusion, heat sealing, ultrasonic welding, laser welding, and the like. In some cases, the collapsible container 425 may be detached from the collapsible container neck 420. For example, a person utilizing the HPC 405 during an outdoor activity can use and finish the liquid edible material in the collapsible container 425 and detach the collapsible container neck 420 from the collapsible container 425. In some cases, the collapsible container 425 may be thrown to the trash bin after the liquid edible material is used. In some other cases, the collapsible container 425 may be put in a recycle been. In such cases, the collapsible container 425 may be refilled with a liquid edible material and attached to the pump 407.

In some possible embodiments of the disclosed subject matter, the collapsible container 425 may be inserted into a portable coverage 430 designed to protect the collapsible container 425. The wearable coverage 430 may also allow a person utilizing the HPC to carry the HPC during outdoor activities. Such outdoor activities may be running, walking, cycling, diving, sky diving, water skiing, rafting, sailing or other sport activities requiring usage of liquid edible material. In some cases, the portable coverage 430 may comprise a concave socket 433 which allows the nozzle 417 to move upwards and downwards as a part of the pumping and releasing the liquid edible material. For example, a user can release aerosol of the liquid edible material by pushing down the airless-pump 410, and allowing the airless-pump 410 to move up. In such cases, the nozzle 417 may move along the concave socket 433.

FIG. 4B shows an assembled HPC inserted into a wearable coverage, in accordance with exemplary embodiments of the disclosed subject matter. FIG. 4B shows an assembled view of HPC 405 comprising a collapsible container 425 inserted into a wearable coverage 430. The wearable coverage 430 may be designed with a concave socket 433 which allows the nozzle 417 to move upwards and downwards as a part of the pumping and releasing the liquid edible material residing within the collapsible container 425.

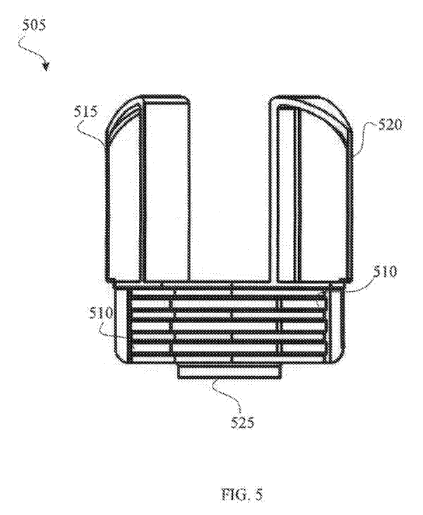

FIG. 5 shows a container neck designed to be attached to the inner sidewalls of a collapsible container, in accordance with exemplary embodiments of the disclosed subject matter. Container neck 505 is designed to be inserted into a collapsible container and be attached to inner sidewalls of said collapsible container. The container neck 505 comprises protuberant strips 510 extending from the body of the container neck and designed to be fastened to the inner sidewalls of the collapsible container. In some cases, the protuberant strips 510 may fit into dedicated niches protruding from the inner sidewalls of the collapsible container. The container niches may be shaped to be fastened with the protuberant strips 510.

The container neck 505 also comprise a hollow cylindrical section 525 via which the pump dispenser is inserted into the collapsible container. In some cases, the pump container 415 may be threaded into the cylindrical section 525 in order to reach the liquid edible material residing in the collapsible container. In some cases, a screw thread may be formed in the inner side of the cylindrical section 525. Thus, the pump container may have a corresponding screw thread to allow screwing the pump to the container neck 505. The container neck 505 also comprises supporting edges 515 and 520 extending upwards from the body of the container neck 505. The supporting edges 515 and 520 may be designed to limit the lateral movement of the pump head and maintain the pump head direction to facilitate the person using the HPC to dispense the liquid material to his/her mouth. In some cases, a person utilizes the HPC may also use the supporting partitions 515, and 520 to grip the HPC with the finger. For example, a person can utilize the thumb and the middle finger to grip the HPC by the supporting partitions 515, and 520, in a gesture like a pinch gesture. A person griping the HPC by the fingers may also be able to utilize the index finger to press the pump head downwards.

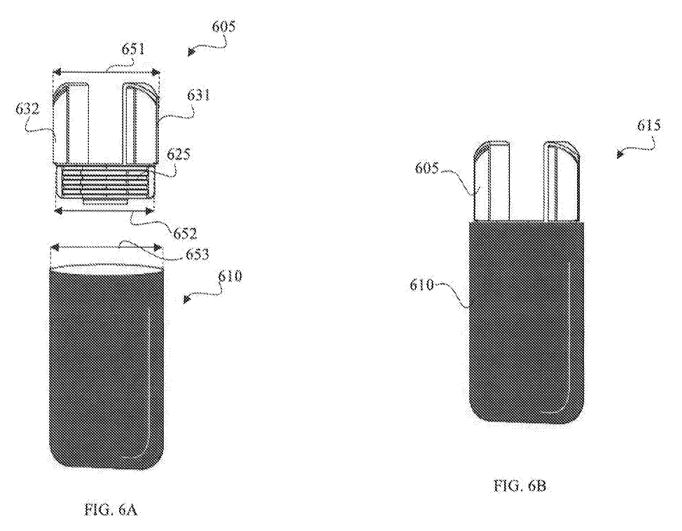

FIG. 6A shows a container neck and collapsible container, in accordance with exemplary embodiments of the disclosed subject matter. Container neck 605 comprises protuberant strips 625 designed to be inserted into the collapsible container 610. The container neck 605 also comprises supporting edges 631 and 632 designed to limit the lateral movement of the pump and to provide with a convenient place for grasping the HPC. FIG. 6A also shows arrow 653 demonstrating the width of the collapsible container 610, arrow 652 demonstrating the width of the protuberant strips 625, and arrow 615 demonstrating the width of the supporting edges 631, and 632. In some cases, the width of the protuberant strips 625 shown by arrow 653 may fit to be inserted accurately into the collapsible container 610. The supporting edges 631 and 632 may be wider than the width of the collapsible container 610, thus, the supporting edges 631 and 632 may function as a barrier which limits the container neck 605 when attached to the collapsible container 610.

FIG. 6B shows a container neck inserted into a collapsible container, in accordance with exemplary embodiments of the disclosed subject matter. Container neck 605 is inserted into the collapsible container 610. In some cases, the collapsible container neck 605 may be fastened into the collapsible container 610 by an adhesive such as hot melted adhesives, cold adhesives, and the like. In some cases, the collapsible container neck 605 may be welded to the inner sidewalls of the collapsible container.

In some possible embodiments of the disclosed subject matter, the collapsible container 610 may be configured to be detachable from the container neck 605. Such configuration may be achieved by an adhesive or welding process designed to allow a person to detach the collapsible container 610 from the container neck 605. For example, a person can utilize the liquid material residing in the collapsible container 610 and then tear the collapsible container 610 from the container neck 605.

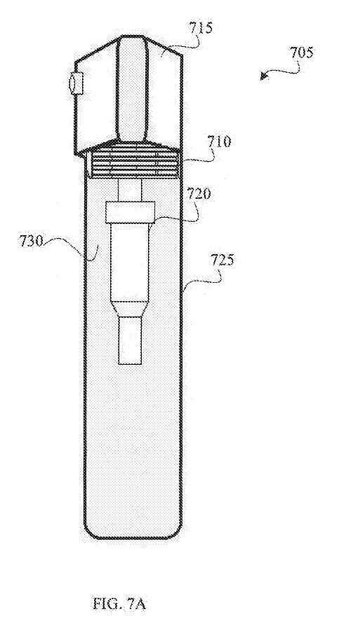

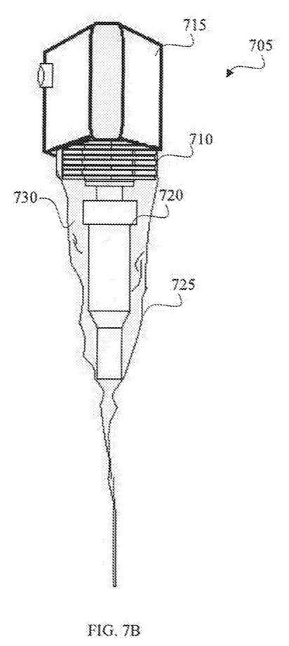

FIG. 7A shows a lateral view of a cross section of a HPC comprising a liquid edible material, in accordance with exemplary embodiments of the disclosed subject matter. FIG. 7A shows a HPC 705 comprising a dispenser 715 and protuberant strips 710 inserted into a collapsed container 725. The HPC 705 further comprises a pump 720 resides in the collapsible container 725.

The pump 720 may be configured to create a vacuum during the emptying process of the collapsible container 725 and thereby to cause the collapsible container 725 to collapse after each time the pump 720 draws the liquid from the collapsible container 725. The vacuum created by the pump 720 may be utilized to push the liquid material toward the pump 720 and thereby enable emptying of the collapsible container 725. FIG. 7B also shows a liquid edible material 730 (colored in gray) which resides in the collapsible container 725 container 725. The collapsed container 725 is swollen up to the maximal size of the collapsible container 725.

FIG. 7B shows a lateral view of a cross section of a collapsed HPC comprising a liquid edible material, in accordance with exemplary embodiments of the disclosed subject matter. FIG. 7B shows a HPC 705 comprising a dispenser 715, and protuberant strips 710 inserted into a collapsed container 725. The protuberant strips 710 inserted into the collapsed container 725 may seal the collapsed container 725 and prevent an ingress of air from the atmosphere.

The HPC 705 further comprises a pump tube 720 residing in the collapsed container 725. The pump tube 720 may be configured to create a vacuum during the emptying process of the collapsed container 725 and thereby to cause the collapsed container 725 to collapse. The vacuum created by the pump tube 720 may utilized to push the liquid edible material toward the pump 720 and thereby allow an emptying collapsed container 725. FIG. 7B also shows a liquid material 730 (colored in gray) which resides within the collapsed container 725. The collapsed container 725 may be collapsed and squeezed at the portion beneath the pump tube 720 and swollen out at the portion of the collapsed container 725 which is closer to the dispenser 715. Such a squeezing and collapsing of the collapsed container 725 may be achieved by the differential between the inner pressure of the collapsed container 725 and the atmospheric pressure level existing outside of the HPC 705.

In some cases, a person utilizing the disclosed subject matter may be able to squeeze the collapsed container 725 at the upper portion which is closer to the dispenser 715. Such a squeezing may exert pressure on the liquid edible material 730 and thereby push the liquid edible material 730 down to the portion of the collapsed container 725 elongating beneath the pump 720. In some cases, such a squeezing may allow a person to consume the liquid edible material 730 remaining in some portions of the collapsed container 725 which the suction of the pump may not reach. For example, in case some amount of a liquid material 730 exists in an upper portion of the collapsed container 725 close to the dispenser 715, a person may decide to use the fingers and palm and squeeze the liquid material 730 downwards in such a manner which pushes the liquid edible material 730 to other portion of the collapsed container 725 which the suction of the pump can be reached. Then, the person can utilize the dispenser 715 to release the pushed liquid material 730 outwards.

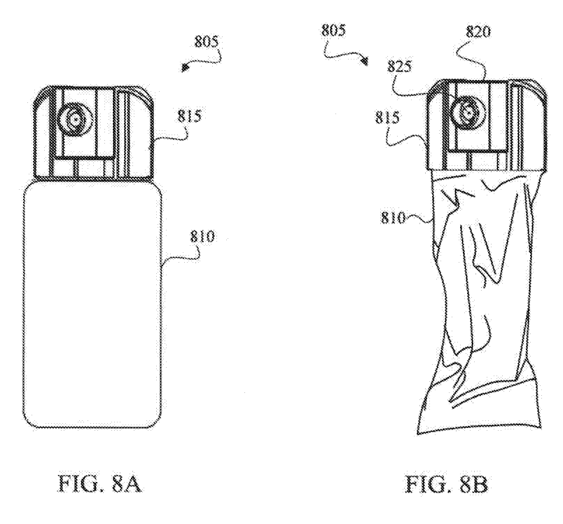

FIG. 8A shows a front view of an HPC comprising a liquid material, in accordance with exemplary embodiments of the disclosed subject matter. HPC 805 comprises a container neck 815 shown in a front view. HPC 805 also comprises a collapsible container 810 containing a liquid material (not shown). In some cases, the liquid material may be pressed into the collapsible container 810 in a pressure level which may swell up the collapsible container 810 to its maximal size. Such pressure level may shape the collapsible container 810 to be in a stretched and rigid form. In some other cases, the liquid material may be pressed into the collapsible container 810 in a pressure level which may swell the collapsible container 810 to less than its maximal size. Such pressure level may shape the collapsible container 810 to be in a soft and loose form.

FIG. 8B shows a front view of an HPC which is partially full with a liquid material, in accordance with exemplary embodiments of the disclosed subject matter. HPC 805 comprises a container neck 815 shown in a front view. The HPC 805 comprises a collapsed container 810 which may be empty or partially full with liquid material (not shown). In some cases, such a collapsed structure may be formed due to usage of the HPC 805, for example, in cases a person utilizes the HPC 805 and consumes a portion of the liquid material residing in the collapsed container 810. The collapsed container 805 may be sealed and impenetrable to air outside the collapsed container 810. Thus, the air pressure in the atmosphere may press and collapse the collapsed container 810 and thereby achieve an equilibrium between the pressure exerted on the collapsed container 810 from the outside and the pressure within the collapsed container 810 exerted from inside of the collapsed container 810.

The HPC 805 may also be configured to release the liquid material by the pump dispenser 820 designed to draw the liquid edible material and then to release the liquid edible material out via orifice 825. In some cases, once a portion of the liquid edible material is released out via orifice 825, the pressure within the collapsed container 810 exerted from inside of the collapsed container 810 may reduce. In such cases, the equilibrium point may change, and the outside pressure exerted on the collapsed container 810 from the outside may be larger than the pressure within the collapsed container 810 exerted from inside of the collapsed container 810. Thus, the collapsed container 810 may continue to collapse until a new equilibrium point is achieved.

In possible embodiments of the disclosed subject matter, the collapsible container may be formed of lamented films of impermeable material. Such an impermeable material can prevent the ingress of another material, such as gases, flavors or aromas, water vapors, oil, light, and the like, into the collapsible container. For example, according to a possible aspect of the present invention, the HPC can comprise some laminated films such as: A film made of Biaxially-oriented Polyethylene terephthalate, a film made of polyethylene, a film made of Ethylene vinyl alcohol, a film made of aluminum, a film made Polyethylene terephthalate coated with a thin layer of metal, a film made of plastic, or any combination thereof. In some cases, the laminated films may not block the ingress of Oxygen. In some cases, some of the laminated films may be adhered, one to each-other by a high solids and high performance solvent-based laminating adhesives.

The collapsible container may be compounded from polyesters such as polyethylene, Polyethylene terephthalate, Ethylene vinyl alcohol, Polylactic acid (PLA), Polyhydroxyalkanoate, and the like. In some cases, the collapsible container may be compounded from films formed of paper, transparent polyester films, films comprising photopolymers, films comprising biodegradable material such as biodegradable polymer, and the like. For example, in some embodiments of the present invention, the container may comprise acrylate polymer films, or in some cases, methyl acrylate films, or in some cases, polychlorotrifluoroethylene films, or in some cases, vinylidene chloride methyl acrylate copolymer films, or in some cases, acrylonitrile methyl acrylate copolymer films. In some other cases, the collapsible container may also comprise metallic ingredients such as aluminum. In possible embodiments of the disclosed subject matter the collapsible container may nondurable for a disposable usage. For example, a person utilizes the HPC during an outdoor activity can use and finish the liquid edible material in the collapsible container and then, throw HPC to the trash bin, or in some cases to the recycle bin.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A package for liquid materials, comprising:
a collapsible container comprising inner sidewalls for storing said liquid materials;
a container neck attached to the inner sidewalls of an upper portion of said collapsible container;
an airless pump dispenser comprises a pump container, said pump container is configured to be inserted into the collapsible container through the container neck, wherein the pump container reaches the liquid materials residing in the collapsible container;
a cap cover mounted on said airless pump dispenser and comprising a nozzle extending outwards, said nozzle is designed to release said materials out from the collapsible container, wherein said cap cover is designed to be pressed downwards and upwards and thereby to dispense the liquid material residing in said collapsible container;
two rigid supporting edges extending upwards from two lateral edges of an upper portion of the container neck, wherein the two rigid supporting edges are configured to maintain said nozzle between the two rigid supporting edges when the cap cover is pressed downwards; and wherein said two rigid supporting edges are designed to allow a user to grip the container neck without squeezing the collapsible container.

2. The package for liquid materials of claim 1, wherein the package further comprises a wearable coverage designed to contain the collapsible container inserted into said wearable coverage.

3. The package for liquid materials of claim 1, wherein the container neck further comprises protuberant strips which fit to be inserted accurately into the upper portion of said collapsible container and thereby fasten and seal the collapsible container and wherein the collapsible container further comprises dedicated niches protruding from the inner sidewalls of the collapsible container which fit to the protuberant strips of the container neck such that the protuberant strips and the dedicated niches fasten and seal the collapsible container.

4. The package for liquid materials of claim 1, wherein the cap cover is connected to a bellows member mounted on said container neck, and wherein said bellows member functions as a spring mechanism which pushes the cap cover upwards and thereby allows the liquid material to be pushed into the pump container of the airless pump dispenser.

5. The package for liquid materials of claim 1, wherein the pump is configured to release the liquid material in a form of an aerosol spray.

6. The package for liquid materials of claim 1, wherein the collapsible container is compounded of films.

7. The package for liquid materials of claim 1, wherein the collapsible container is made of a humidity impermeable material.

8. The package for liquid materials of claim 7, wherein the collapsible container is compounded of films comprising PLA.

9. The package for liquid materials of claim 7, wherein the collapsible container is compounded of films comprising biodegradable material.

10. The package for liquid materials of claim 7, wherein the collapsible container is compounded of films comprising polymers.

11. The package for liquid materials of claim 7, wherein the collapsible container is compounded of films comprising paper.

12. The package for liquid materials of claim 7, wherein the collapsible container is compounded of films comprising metallic ingredients.

13. The package for liquid materials of claim 9, wherein the collapsible container is compounded of films formed with acrylic acid.

14. The package for liquid materials of claim 1, wherein the container neck is adhered to the collapsible container by adhesives comprising Cyanoacrylates.

15. The package for liquid materials of claim 1, wherein the container neck is adhered to the collapsible container by hot melted adhesives.

16. The package for liquid materials of claim 1, wherein the container neck is adhered to the collapsible container by cold adhesives.

17. The package for liquid materials of claim 1, wherein the container neck is welded to the collapsible container by laser welding.

18. The package for liquid materials of claim 1, wherein the container neck is welded to the collapsible container by heat fusion.

19. The package for liquid materials of claim 1, wherein the container neck is welded to the collapsible container by heat sealing.

20. The package for liquid materials of claim 1, wherein the container neck is welded to the collapsible container by ultrasonic welding.

21. The package for liquid materials of claim 1, wherein the container neck is designed to be detached from said collapsible container.

22. The package for liquid materials of claim 2, wherein said wearable coverage further comprises a socket which allows the airless pump dispenser and the nozzle to move upwards and downwards as a part of the pumping and thereby to release the liquid material.
